(19) United States
(12) Patent Application Publication
(10) Pub. No.: US 2007/0256521 A1
(43) Pub. Date: Nov. 8, 2007

(54) Bottle Opener

(76) Inventor: Pedro Maria Rebordinos Villalba, Gessa Naut Aran (ES)

Correspondence Address: LADAS & PARRY, 26 WEST 61ST STREET, NEW YORK, NY, 10023, US

(21) Appl. No.: 11/596,485

(22) PCT Filed: May 12, 2005
(86) PCT No.: PCT/ES05/00260

§ 371 Date: Nov. 13, 2006

(30) Foreign Application Priority Data
May 13, 2004 (ES) P200401151

(51) Int. Cl. B67B 7/16

(52) U.S. Cl. 81/3.31

(57) ABSTRACT

Decapper consisting of a monopiece body, configured with a straight profile of angular section and symmetrical, whose sides have flaps that are noticeably arched inwards, ending in sharp edges, in such a way that in both directions they make it possible to retain the edges of the crown-type bottle caps, so that they may be decapped through a levering or movement of the bottle in question.

### OBJECT OF THE INVENTION

The invention refers to a decapper, in other words to a device especially conceived to remove caps or sealing lids from bottles, of the type commonly referred to as “crown” caps.

The object of the invention is to obtain a static decapper, destined to form part of a likewise static support, for example a bar or counter of a public establishment that serves drinks, such as a bar, restaurant, cafeteria or similar; a decapper that with an extremely simple and consequently inexpensive structuring, offers numerous advantages.

### BACKGROUND TO THE INVENTION

As is known, caps or crown caps used for closing bottles materialize in a metal disk, with a suitably coated internal face, which is fixed through stapling to bottle rims, defining a perimeter skirt with a dented profile. To eliminate these caps, decappers are used that, leaning against a margin region of the cap base, act by levering against the opposite edge of the skirt causing the cap's deformation and removal.

There are innumerable solutions to achieve this decapping effect, each and every one materializing in a manual implement or device that, acting as a lever, makes it possible to perform the previously described manoeuvre.

These implements present a two-sided problem:

On the one hand, they constitute a portable implement, of a reduced size, which is easily lost, meaning that frequently a waiter needing to use the decapper does not remember where it was left the last time it was used, with the ensuing loss of time required to find it. To solve this problem, often a piece of string is used or a chain that attaches the decapper to the user, for example to the belt strap or hook in a pair of trousers, which is an unaesthetic and not very practical solution.

To decap the bottle, both hands are needed, one to hold the bottle and another with which to activate the decapper, and even then there is a permanent risk of the bottle swaying during the manoeuvre and partially spilling its content.

In an attempt to avoid this problem static decappers are known, that are designed to be fixed for example to an establishment's counter, which avoids the problem of having to find it, but in turn this solution presents a two-sided problem, on the one hand, devices for this purpose are complicated and costly, and on the other they cannot be used simultaneously by two or more people, adding to which frequently its location within the establishment while it may be convenient for one or some of its employees, may also be inconvenient for others.

### DESCRIPTION OF THE INVENTION

The decapper proposed by the invention, with an extremely simple and consequently inexpensive structuring, resolves the previously described problems in a fully satisfactory manner in all of the aspects mentioned.

More specifically, the decapper belongs to the type of static decappers, in other words it is destined to be fixed to a counter, bar or similar, and consists of an angular profile, of indefinite length, whose branches finish in longitudinal flaps bent inwards determining respective sharp edges, noticeably coplanary, with the profile having on one of its branches at least a pair of end orifices, so that it may be screwed onto the edge of the counter, bar or element in question, while its other branch is a coplanary extension of the bar, counter, or similar.

Thanks to its special profile, the edge of the cap can be hooked on the edge of either of the two abovementioned flaps, and, by pressing the base of the cap on the other, a movement of levering the bottle will cause its automatic decapping.

This profile can have any length, in such a way that it allows various bottles to be decapped simultaneously, on the part of several or more waiters, and with an appropriate modularity can run the best part of the length of the bar, even its full length, in such a way that it is directly and immediately available in any point of the establishment where the decapper may be required.

### DESCRIPTION OF THE DRAWINGS

To complement the description being made and with a view to contributing to a better understanding of the characteristics of the invention, according to a preferable example of its practical embodiment, we accompany as an integral part of this description, a set of drawings where, by way of illustration but not limitation, the following has been represented:

FIG. 1 shows the profile of a decapper realized in accordance with the object of the present invention.

FIG. 2 shows a partial front elevation view of the same decapper.

FIG. 3 shows the profile of the decapper of the previous figures duly fixed to the edge of a counter and in its operating position.

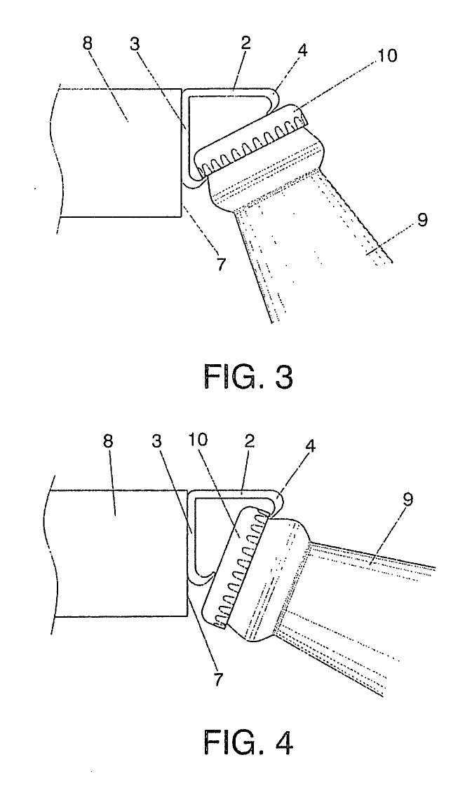

Finally, FIG. 4 shows a similar representation to FIG. 3 corresponding to a second possibility for using the decapper.

### PREFERABLE EMBODIMENT OF THE INVENTION

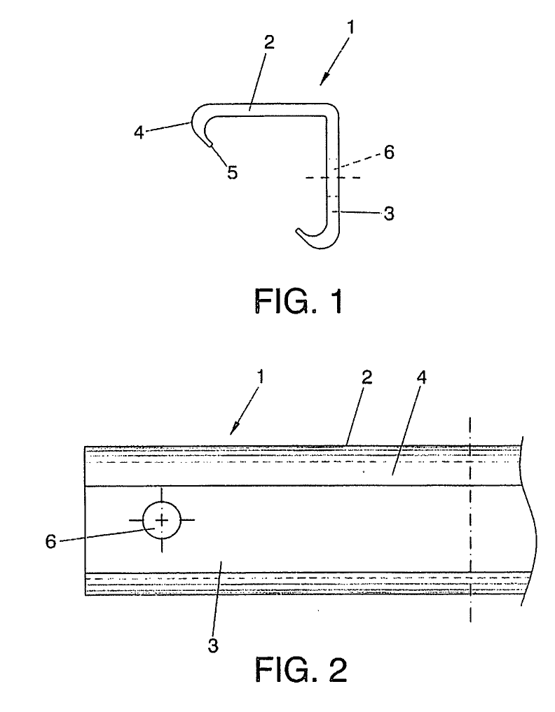

From the abovementioned Figures it is possible to see how the decapper proposed by the invention consists of a monopiece body (1), of a constant profile, specifically a diedric profile and preferably straight, whose side branches (2) and (3) finish at their free end in corresponding flaps (4), noticeably arched inwards, and ending in sharp branches (5), that are left facing opposite each other as shown in FIG. 1.

One of the side branches (3) of said body (1) has at least one pair of end orifices (6), whose number may be greater depending on the length of the body (1), length that in principle is indefinite, in such a way that through said orifices (6) and with the use of wall plugs or similar fixing devices, the decapper is attached to the inner edge (7) of a counter (8), bar or similar, of which the other branch (2) is a coplanary extension, as shown in FIG. 3.

As already mentioned above, the profile (1) may have any length considered suitable, in all events a considerable length, in such a way that what could be called a “running” decapper is obtained, capable of affecting even the full length of a counter's edge.

The device can be used in two ways, using always exclusively one hand to manipulate the bottle (9), one as shown in FIG. 3, in which the lower flap (4) of the decapper acts on the lower edge of the cap (10), supporting the latter on the flap (4) of the upper branch (2), and in which to eliminate the cap it is necessary to lever the bottle (9) in an upwards direction, and with another one shown in FIG. 4, opposite to the preceding one, in which the bottle (9) must be levered downwards in order for the bottle to be decapped.

1. Decapper of the type destined to act on the cap of a bottle to deform and open said cap, and of the type designed to be fixed in a static manner to a counter, bar or similar, characterized in that it consists of a monopiece body of a symmetrical constant profile, preferably a straight profile, one of whose branches is destined to adapt and fix to the inner edge of the counter, bar, or element in question, while the other is designed to constitute a coplanary extension of the operative surface of said counter or similar, with said body incorporating in correspondence with the free ends of its branches respective flaps noticeably arched inwards, finishing in sharp edges facing opposite each other for acting on the cap, with said body presenting a considerable length, which can vary according to the requirements of each case.

2. Decapper, according to claim 1, characterized in that the cited mono-piece body incorporates in one of its branches, specifically the one to be fixed to the edge of the counter, bar, or similar, at least one pair of orifices at its ends to be fixed by screwing onto said edge.

3. Decapper, according to claim 1, characterized in that its sharp edges define indistinctively, both in one as in the other, zones of sup-port on the base of the cap and zones of hooking the free edge of its dented skirt.

4. Decapper, according to claim 2, characterized in that its sharp edges define indistinctively, both in one as in the other, zones of sup-port on the base of the cap and zones of hooking the free edge of its dented skirt.
